(19) United States
(12) Patent Application Publication
(10) Pub. No.: US 2023/0385872 A1
(43) Pub. Date: Nov. 30, 2023

(54) Analysis System for Advertising Effectiveness

(71) Applicant: Meshplus Co., Ltd., Taipei (TW)

(72) Inventors: Kuang-Jui Hu, Taipei (TW); Ying-Hsueh Tseng, Taipei (TW); Po-Hsun Wang, Taipei (TW)

(73) Assignee: Meshplus Co., Ltd., Taipei (TW)

(21) Appl. No.: 18/097,796

(22) Filed: Jan. 17, 2023

(30) Foreign Application Priority Data
May 26, 2022 (TW) 111119610

(51) Int. Cl. G06Q 30/0242; G06Q 30/0251

(52) U.S. Cl. CPC G06Q 30/0246; G06Q 30/0244; G06Q 30/0251

(57) ABSTRACT

The present invention discloses an analysis system for advertising effectiveness comprising a user data receiving module, a merchant visiting data analysis module and an advertising effectiveness processing module. The user data receiving module derives a target advertising audience data cluster from first raw data which are advertisement data before the advertisement is advertised. The merchant visiting data analysis module sorts a merchant visitor data cluster from second raw data which are advertisement data after the advertisement is advertised. The advertising effectiveness processing module is connected to the user data receiving module and the merchant visiting data analysis module and derives an overlapping proportion of the visitor amount.

### FIELD OF THE INVENTION

The present invention relates to an analysis system more particularly relates to an analysis system for advertising effectiveness.

### BACKGROUND OF THE INVENTION

An advertisement is a propagating medium for attracting consumers to purchase or be acquainted with commodities or services, and is also a platform for broadcasting business information. Through advertising, the consumers are brought to the attention of commodities sold by business stores and prompted to buy the commodities. Therefore, the business stores can prompt business sales of the commodities via advertisement.

However, in the current advertising practices, the business stores which purchase advertising services cannot obtain a direct relevance between the business stores' revenue performances and the advertisement. Specifically, although the business stores can determine whether advertising is effective for the revenue performances by comparing the variations of the revenue performances and an advertising time period, the determining manner above is only a reference speculation without direct relevance between the business stores' revenue performances and the advertisement, because the variations of the revenue performances may be caused by multi-faced influences and there is no necessary correlation between the revenue performances and the advertising.

### SUMMARY OF THE INVENTION

Therefore, one object of the present invention is to provide an analysis system for advertising effectiveness, which can directly obtain an effectiveness of advertising for potential consumers so as to adjust a strategy direction of advertising and marketing.

In order to overcome the technical problems in prior art, the present invention provides an analysis system for advertising effectiveness which evaluates effectiveness of prompting advertising audiences by advertising an advertisement of a specific merchant in advertising channels, the analysis system comprising: a user data receiving module which receives first raw data, wherein the first raw data is advertisement data before the advertisement is advertised, the first raw data contains a plurality of to-be-analyzed user data, each to-be-analyzed user data is corresponding to a to-be-analyzed individual, wherein the user data receiving module derives, from the first raw data, a target advertising audience data cluster which is a cluster of the to-be-analyzed user data of the to-be-analyzed individuals designated as the advertising audiences; a merchant visiting data analysis module which receives a second raw data, wherein the second raw data is advertisement data after the advertisement is advertised, the second raw data contains a plurality of visiting user data, each visiting user data is corresponding to a visitor, wherein the merchant visiting data analysis module sorts, from the second raw data, a merchant visitor data cluster which is a cluster of the visiting user data containing a website visiting history of an online website of the specific merchant on which the visitor has visited and/or an offline point visiting history of an offline store of the specific merchant on which the visitor has visited; and an advertising effectiveness processing module being connected to the user data receiving module and the merchant visiting data analysis module, wherein the advertising effectiveness processing module derives, according to the target advertising audience data cluster and the merchant visitor data cluster, a proportion of people amount for people who are visitors belonging to both the target advertising audience data cluster and the merchant visitor data cluster to the people amount for people who are the to-be-analyzed individuals of the target advertising audience data cluster to obtain to-be-analyzed individual overlapping proportion information as an advertising channel effectiveness index.

In one embodiment of the present invention, an analysis system for advertising effectiveness is provided, wherein the to-be-analyzed user data corresponding to the to-be-analyzed individual contains a to-be-analyzed user identification code, the visiting user data corresponding to the visitor contains a visiting user identification code, the advertising effectiveness processing module derives the visitors belonging to both the target advertising audience data cluster and the merchant visitor data cluster by performing a comparison between the to-be-analyzed user identification code of the to-be-analyzed individual and the visiting user identification code of the visitor.

In one embodiment of the present invention, an analysis system for advertising effectiveness is provided, wherein the to-be-analyzed user identification code is obtained by performing a de-identification process on real identity features of the to-be-analyzed individual, and the visiting user identification code is obtained by performing a de-identification process on real identity features of the visitor.

In one embodiment of the present invention, an analysis system for advertising effectiveness is provided, wherein the merchant visiting data analysis module is connected to an external database to receive the second raw data from the external database.

In one embodiment of the present invention, an analysis system for advertising effectiveness is provided, wherein the merchant visiting data analysis module contains a website visiting data analysis unit, the website visiting data analysis unit derives, according to a domain name format, the website visiting history of the visiting user data from the second raw data.

In one embodiment of the present invention, an analysis system for advertising effectiveness is provided, wherein the merchant visiting data analysis module contains a store visiting data analysis unit, the store visiting data analysis unit derives, according to a default address data format, the offline point visiting history of the visiting user data from the second raw data, the default address format contains Arabic numerals, commas and decimal point.

In one embodiment of the present invention, an analysis system for advertising effectiveness is provided, wherein the offline point visiting history of the visiting user data contains longitude and latitude data of the offline store which the visitor has visited.

The analysis system for advertising effectiveness of the present invention has the technical effects as follows. The present invention can directly obtain an effectiveness of advertising for potential consumers so as to adjust a strategy direction of advertising and marketing.

### BRIEF DESCRIPTION OF THE DRAWINGS

FIG. 1 is a schematic block diagram illustrating an analysis system for advertising effectiveness according to one embodiment of the present invention;

FIG. 2 is a schematic diagram illustrating a target advertising audience data cluster of the analysis system for advertising effectiveness according to the embodiment of the present invention;

FIG. 3 is a schematic diagram illustrating a merchant visitor data cluster of the analysis system for advertising effectiveness according to the embodiment of the present invention;

FIG. 4 is a schematic diagram illustrating a process of obtaining a website visiting history and an offline point visiting history by a merchant visiting data analysis module of the analysis system for advertising effectiveness according to the embodiment of the present invention; and

FIG. 5 is a schematic diagram illustrating a process of obtaining an advertising channel effectiveness index by an advertising effectiveness processing module of the analysis system for advertising effectiveness according to the embodiment of the present invention.

### DETAILED DESCRIPTION OF THE PREFERRED EMBODIMENTS

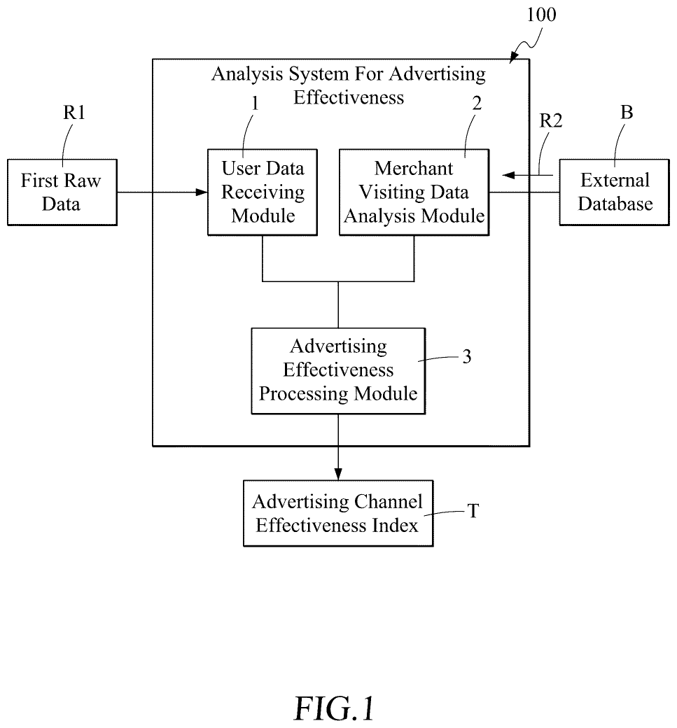

The preferred embodiments of the present invention are described in detail with reference to FIGS. 1 to 5. The description is used for explaining the embodiments of the present invention only, but not for limiting the scope of the claims.

As shown in FIG. 1, an analysis system 100 for advertising effectiveness according to one embodiment of the present invention is provided to evaluate effectiveness of prompting advertising audiences by advertising an advertisement of a specific merchant in advertising channels. The analysis system 100 comprises a user data receiving module 1, a merchant visiting data analysis module 2 and an advertising effectiveness processing module 3. Therefore, the analysis system 100 for advertising effectiveness of the present invention can obtain an effectiveness of advertising for potential consumers so as to adjust a strategy direction of advertising and marketing.

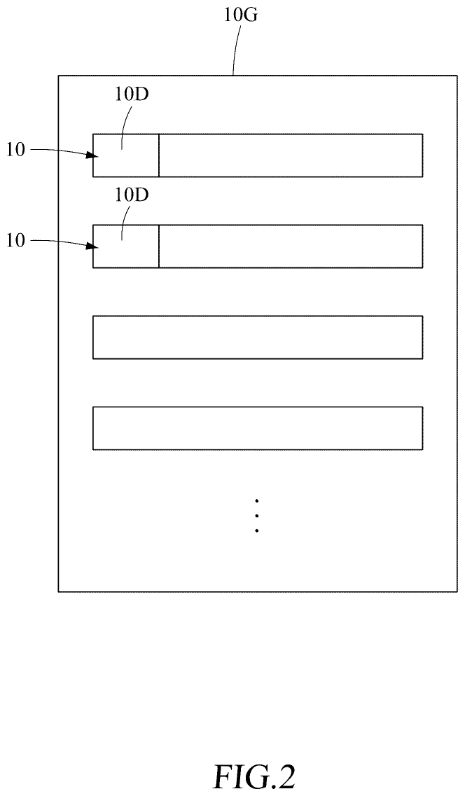

As shown in FIGS. 1 and 2, the user data receiving module 1 receives first raw data R1, wherein the first raw data R1 are reference data before the advertisement is advertised. The first raw data R1 contains a plurality of to-be-analyzed user data 10, wherein each to-be-analyzed user data 10 is corresponding to a to-be-analyzed individual. The user data receiving module 1 derives, from the first raw data R1, a target advertising audience data cluster 10G which is a cluster of the to-be-analyzed user data 10 of the to-be-analyzed individuals designated as the advertising audiences.

Specifically, as shown in FIGS. 1 and 2, the user data receiving module 1 obtains the first raw data R1 from an advertising platform, wherein each of the to-be-analyzed user data 10 of the first raw data R1 contains a to-be-analyzed user identification code 10D corresponding to the to-be-analyzed individual, i.e., the individual designated as an advertising audience by the advertising platform. Moreover, the to-be-analyzed user identification code 10D is obtained by performing a de-identification process, and therefore real identity features of the to-be-analyzed individual will not be revealed. In other words, in compliance with the Personal Data Protection Act, the present invention obtains each to-be-analyzed individual's data of the target advertising audience data cluster 10G by the user data receiving module 1, and the to-be-analyzed individual's data are used as the basis for analyzing and determining advertising effectiveness.

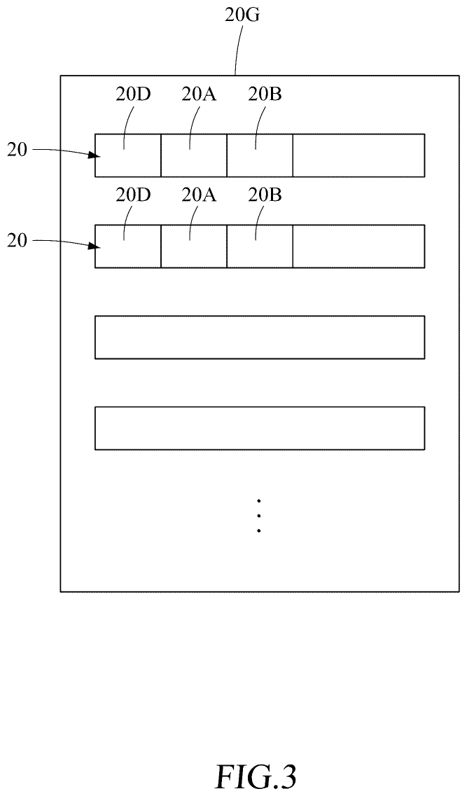

As shown in FIGS. 1 and 3, the merchant visiting data analysis module 2 receives a second raw data R2, wherein the second raw data R2 are comparison data after the advertisement is advertised. The second raw data contains a plurality of visiting user data 20, wherein each visiting user data 20 is corresponding to a visitor. Moreover, the merchant visiting data analysis module 2 sorts, from the second raw data R2, a merchant visitor data cluster 20G which is a cluster of the visiting user data 20 containing a website visiting history 20A of an online website of the specific merchant on which the visitor has visited and/or an offline point visiting history 20B of an offline store of the specific merchant on which the visitor has visited.

Specifically, as shown in FIG. 1, according to the analysis system 100 for advertising effectiveness of one embodiment of the present invention, the merchant visiting data analysis module 2 is connected to an external database B to receive the second raw data R2 from the external database B. The external database B can be obtained from a telecommunications data provider but not limited thereto. Moreover, a visiting user identification code 20D corresponding to the visiting user data 20 is obtained by performing a de-identification process on real identity features of the visitor in the external database B.

Furthermore, in a specific embodiment of the present invention, the to-be-analyzed user identification code 10D corresponding to the to-be-analyzed user data 10 is also obtained by performing a de-identification process on real identity features of the to-be-analyzed individual in the external database B. In other words, if the to-be-analyzed individual and the visitor are the same individual, the to-be-analyzed user identification code 10D will be the same as the visiting user identification code 20D. The present invention performs the data processing and analysis on the second raw data R2 without revealing real identity features of the visitor in compliance with the Personal Data Protection Act.

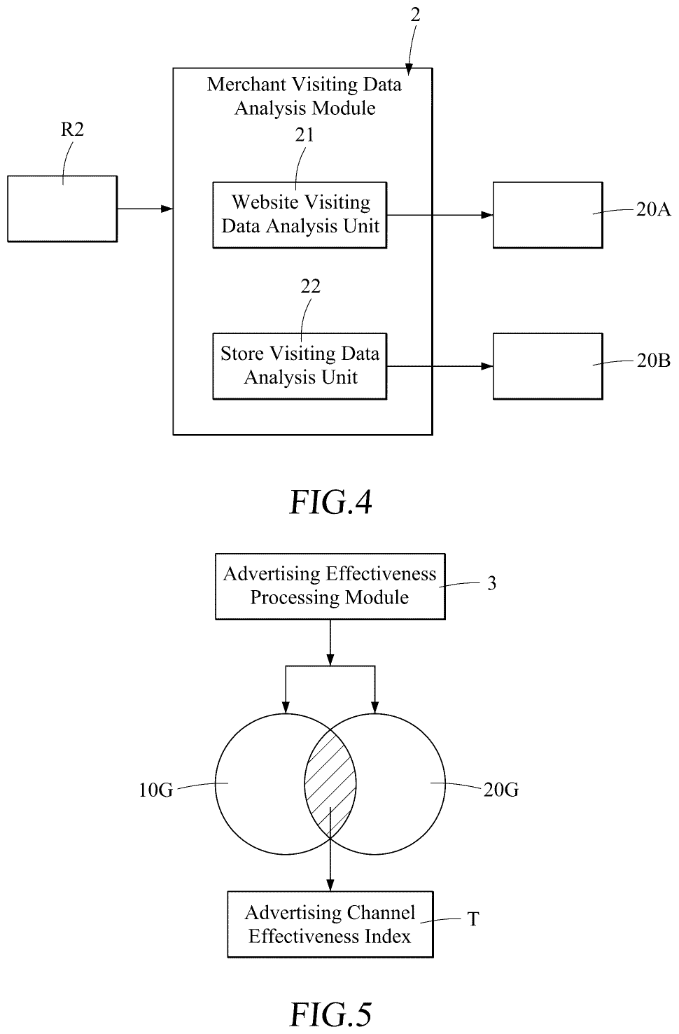

In detail, as shown in FIG. 4, according to the analysis system 100 for advertising effectiveness of one embodiment of the present invention, the merchant visiting data analysis module 2 contains a website visiting data analysis unit 21. The website visiting data analysis unit 21 derives, according to a domain name format, the website visiting history 20A of the visiting user data 20 from the second raw data R2.

In addition, as shown in FIG. 4, according to the analysis system 100 for advertising effectiveness of one embodiment of the present invention, the merchant visiting data analysis module 2 contains a store visiting data analysis unit 22. The store visiting data analysis unit 22 derives, according to a default address data format, the offline point visiting history 20B of the visiting user data 20 from the second raw data R2. The default address format contains Arabic numerals, commas and decimal point.

Furthermore, according to the analysis system 100 for advertising effectiveness of one embodiment of the present invention, the offline point visiting history 20B of the visiting user data 20 contains longitude and latitude data of the offline store which the visitor has visited.

As shown in FIGS. 1 and 5, the advertising effectiveness processing module 3 is connected to the user data receiving module 1 and the merchant visiting data analysis module 2. The advertising effectiveness processing module 3 derives, according to the target advertising audience data cluster 10G and the merchant visitor data cluster 20G, a proportion of people amount for people who are visitors belonging to both the target advertising audience data cluster 10G and the merchant visitor data cluster 20G to the people amount for people who are the to-be-analyzed individuals of the target advertising audience data cluster 10G to obtain to-be-analyzed individual overlapping proportion information.

Therefore, the to-be-analyzed individual overlapping proportion information is obtained by the present invention and served as an advertising channel effectiveness index T. Specifically, the advertising effectiveness processing module 3 compares the to-be-analyzed user identification code 10D of the to-be-analyzed individual with the visiting user identification code 20D of the visitor to find out the visitors belonging to both the target advertising audience data cluster 10G and the merchant visitor data cluster 20G.

In addition, according to the analysis system 100 for advertising effectiveness of one embodiment of the present invention, the amount of the plurality of the to-be-analyzed user data 10 is at least 1,000, and the amount of the plurality of the visiting user data is also at least 1,000. Therefore, the present invention can prevent the real identity features of the to-be-analyzed individual or the visitor from being revealed by cross-comparison due to a too small amount of the to-be-analyzed individual.

The present invention uses “the amount of the visitors who visit the online website and/or the offline store of the specific merchant after receiving advertising information” as the advertising channel effectiveness index T. In other words, the present invention analyzes a predetermined group of people (i.e., the advertising audiences) to find out what proportion of the people would visit the online website and/or the offline store of the specific merchant after receiving the advertising information, and then determines an effectiveness of advertising in prompting potential consumers. Moreover, the present invention can also obtain the consumer enthusiasm caused by the advertising.

It can be known from the above, the analysis system 100 for advertising effectiveness of the present invention utilizes the advertising effectiveness processing module 3 to obtain the to-be-analyzed individual overlapping proportion information by comparing the target advertising audience data cluster 10G with the merchant visitor data cluster 20G (which can indicate what proportion of the to-be-analyzed individuals would be influenced to visit the online website and/or the offline store of the specific merchant by the advertising). In other words, in addition to obtaining the effectiveness of advertising in promoting potential consumers, the present invention can also obtain what proportion of the to-be-analyzed individuals have strong consumer intentions. In this way, the present invention not only facilitates to analyze the effectiveness of the advertising but also provides a reference for adjusting a strategy direction of advertising and marketing.

The above description should be considered as only the discussion of the preferred embodiments of the present invention. However, a person having ordinary skill in the art may make various modifications without deviating from the present invention. Those modifications still fall within the scope of the present invention.

What is claimed is:

1. An analysis system for advertising effectiveness which evaluates effectiveness of prompting advertising audiences by advertising an advertisement of a specific merchant in advertising channels, the analysis system comprising:
a user data receiving module which receives first raw data, wherein the first raw data is advertisement data before the advertisement is advertised, the first raw data contains a plurality of to-be-analyzed user data, each to-be-analyzed user data is corresponding to a to-be-analyzed individual, wherein the user data receiving module derives, from the first raw data, a target advertising audience data cluster which is a cluster of the to-be-analyzed user data of the to-be-analyzed individuals designated as the advertising audiences;
a merchant visiting data analysis module which receives a second raw data, wherein the second raw data is advertisement data after the advertisement is advertised, the second raw data contains a plurality of visiting user data, each visiting user data is corresponding to a visitor, wherein the merchant visiting data analysis module sorts, from the second raw data, a merchant visitor data cluster which is a cluster of the visiting user data containing a website visiting history of an online website of the specific merchant on which the visitor has visited and/or an offline point visiting history of an offline store of the specific merchant on which the visitor has visited; and
an advertising effectiveness processing module being connected to the user data receiving module and the merchant visiting data analysis module, wherein the advertising effectiveness processing module derives, according to the target advertising audience data cluster and the merchant visitor data cluster, a proportion of people amount for people who are visitors belonging to both the target advertising audience data cluster and the merchant visitor data cluster to the people amount for people who are the to-be-analyzed individuals of the target advertising audience data cluster to obtain to-be-analyzed individual overlapping proportion information as an advertising channel effectiveness index.

2. The analysis system for advertising effectiveness as claimed in claim 1, wherein the to-be-analyzed user data corresponding to the to-be-analyzed individual contains a to-be-analyzed user identification code, the visiting user data corresponding to the visitor contains a visiting user identification code, the advertising effectiveness processing module derives the visitors belonging to both the target advertising audience data cluster and the merchant visitor data cluster by performing a comparison between the to-be-analyzed user identification code of the to-be-analyzed individual and the visiting user identification code of the visitor.

3. The analysis system for advertising effectiveness as claimed in claim 2, wherein the to-be-analyzed user identification code is obtained by performing a de-identification process on real identity features of the to-be-analyzed individual, and the visiting user identification code is obtained by performing a de-identification process on real identity features of the visitor.

4. The analysis system for advertising effectiveness as claimed in claim 1, wherein the merchant visiting data analysis module is connected to an external database to receive the second raw data from the external database.

5. The analysis system for advertising effectiveness as claimed in claim 1, wherein the merchant visiting data analysis module contains a website visiting data analysis unit, the website visiting data analysis unit derives, according to a domain name format, the website visiting history of the visiting user data from the second raw data.

6. The analysis system for advertising effectiveness as claimed in claim 1, wherein the merchant visiting data analysis module contains a store visiting data analysis unit, the store visiting data analysis unit derives, according to a default address data format, the offline point visiting history of the visiting user data from the second raw data, the default address format contains Arabic numerals, commas and decimal point.

7. The analysis system for advertising effectiveness as claimed in claim 1, wherein the offline point visiting history of the visiting user data contains longitude and latitude data of the offline store which the visitor has visited.
